(19) United States
(12) Patent Application Publication
(10) Pub. No.: US 2001/0010026 A1
(43) Pub. Date: Jul. 26, 2001

(54) Machining machine

(75) Inventor: Marcel Desmoulins, Mortcerf (FR)

Correspondence Address: YOUNG & THOMPSON, 745 SOUTH 23RD STREET 2ND FLOOR, ARLINGTON, VA, 22202

(73) Assignee: RECOULES S.A.

(21) Appl. No.: 09/760,668

(22) Filed: Jan. 17, 2001

(30) Foreign Application Priority Data
Jan. 20, 2000 (FR) 00 00707

(51) Int. Cl. G06F 19/00

(52) U.S. Cl. 700/169; 700/179; 700/180

(57) ABSTRACT

This pneumatic machining machine comprises a toolholder spindle (14), pneumatic drive means ensuring the drive of the spindle (14) and a central unit (16) which stores programs for controlling the drive means for the execution of machining cycles as a function of the type of tool held by the spindle (14), said spindle (14) being equipped with means (20) for coding the type of tool which it carries, and the machine being provided with means (28) for reading the coding means, which are connected to the central unit (16) in order to supply the latter with information relating to the tool fitted to the spindle. The coding means (20) are arranged in the form of a set of grooves forming an optical code, and the reading means (28) comprise sets of optical fibers for detecting the presence of the grooves.

The present invention relates to a pneumatic machining machine intended particularly to be used in the aeronautical industry.

Pneumatic machines are in widespread use and are often preferred to electrically driven machines because of their performance.

Thus, pneumatic machining machines are known in the prior art, of the type comprising a toolholder spindle, pneumatic drive means ensuring the drive of the spindle and a central unit which stores programs for controlling the drive means for the execution of machining cycles as a function of the type of tool held by the spindle.

In this type of machine, the operator has to select a specific machining program as a function of the task to be carried out, that is to say of the tool which he has fitted to the spindle.

It will be appreciated that such a selection entails a loss of time and is a source of error.

One object of the invention is to overcome these disadvantages.

Its subject is, therefore, a machining machine comprising a toolholder spindle, drive means ensuring the drive of the spindle and a central unit which stores programs for controlling the drive means for the execution of machining cycles as a function of the type of tool held by the spindle, characterized in that said spindle is equipped with means for coding the type of tool which it holds, and the machine is provided with means for reading the coding means, which are connected to the central unit in order to supply the latter with information relating to the tool fitted to the spindle, and in that the central unit comprises, furthermore, means for selecting from the programs stored in the central unit the program corresponding to the tool which is held by the spindle and the coding means of which are read by the reading means.

The machining machine according to the invention may comprise, furthermore, one or more of the following characteristics, taken separately or according to all the technically possible combinations:

the coding means are arranged in the form of a set of annular grooves made on the peripheral surface of the spindle, and the reading means consist of means for the non-contact detection of said grooves,

the means for reading the coding means comprise a network of optical fibres facing towards the grooves and intended for detecting the presence of said grooves on the spindle,

the network of optical fibres comprises optical fibres for detecting the presence of said grooves, with each of which optical fibres is associated an optical fibre for illuminating the peripheral surface of the spindle carrying said grooves,

each optical illuminating fibre associated with an optical fibre for detecting the presence of a groove is assembled in a bundle with the associated optical detection fibre and ensures that the latter is illuminated by reflection on the peripheral surface of the spindle,

each optical illuminating fibre and its optical fibre for detecting the presence of a groove are mounted opposite one another at a distance from the axis of the spindle which is between the distance from the bottom of the corresponding groove to said axis and that from the outer surface of the spindle to said axis,

the selection means comprise, in the central unit, means for comparison between a word prepared from the signal carried by the network of optical fibres and a set of words which are stored in a memory in the central unit, each corresponding to one type of machining tool and with each of which is associated a corresponding machining program,

it comprises three optical fibres for preparing a word of three binary digits serving for controlling the execution of corresponding machining programs,

the toolholder spindle comprises, furthermore, a visual code intended for indicating to an operator the type of tool to be fitted to the spindle, the type of tool indicated by the visual code corresponding to the type of tool coded by the coding means; and

the drive means ensure the advance of the toolholder spindle, and the control programs are programs for controlling the advance of the toolholder spindle.

Other characteristics and advantages may be gathered from the following description given purely by way of example and made with reference to the accompanying drawings, in which:

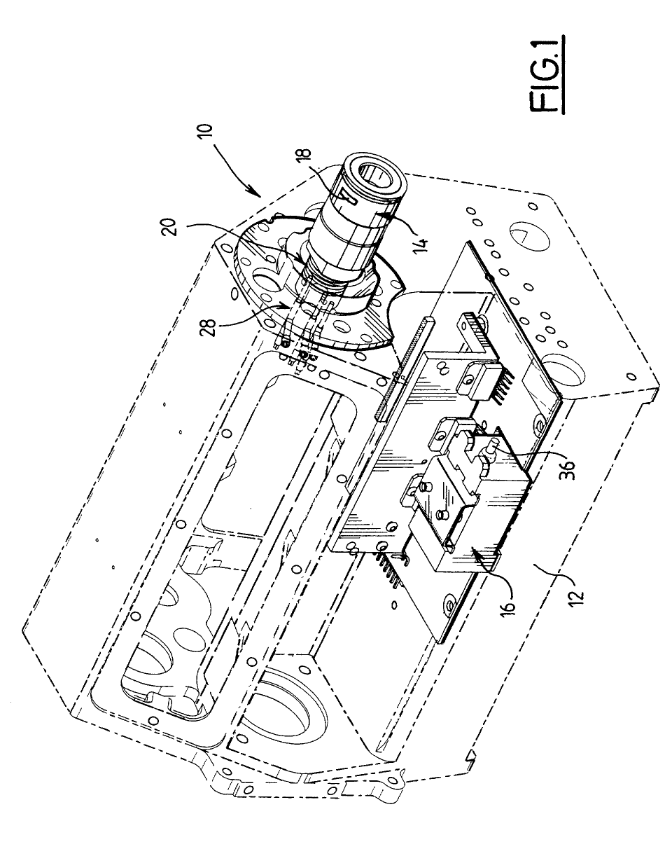

FIG. 1 is a perspective view of part of a machining machine according to the invention,

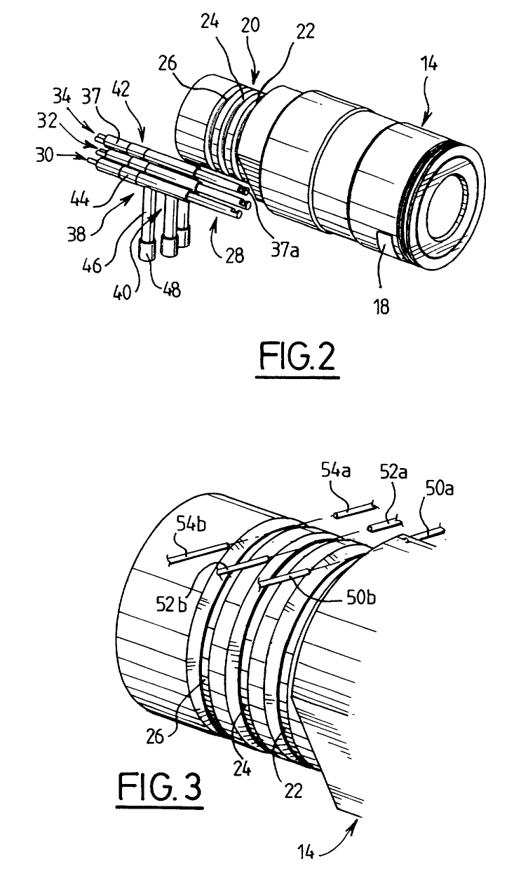

FIG. 2 is a view of a detail of the toolholder spindle, on which are made the coding means and means for reading these coding means, and

FIG. 3 is a view of a detail of the toolholder spindle carrying the coding means with which another embodiment of the reading means is associated.

FIG. 1 illustrates a perspective view of the frame of a machining machine according to the invention designated by the general reference numeral 10.

The machine 10 mainly comprises, mounted on the frame 12, a pneumatic motor (not illustrated) which, by means of a set of pinions, ensures that a toolholder spindle 14 is driven in rotation about a longitudinal axis.

As is conventional, the toolholder spindle may be mounted on a longitudinally displaceable carriage, itself mounted on a screw driven by means of a low-voltage electric motor, for example a stepping motor, so as to control the advance and retreat of the tool fitted to the spindle 14.

Moreover, the frame 12 carries a central processing unit 16 which stores programs for controlling the operation of the machine and, in particular, of the pneumatic motor and also, if appropriate, of the electrical motor so as to ensure the execution of machining cycles, this taking place as a function of the type of tool carried by the spindle 14.

Only the toolholder spindle 14 and the central unit 16 have been illustrated in FIG. 1 for the sake of clarity.

Also referring to FIG. 2, the toolholder spindle 14 carries, on its outer surface, a visual code 18 which, for example, takes the form of listed marks making it possible to indicate to an operator the type of tool which it is appropriate to fit to the spindle 14.

Moreover, the spindle 14 comprises additional coding means 20 taking the form of annular grooves 22, 24 and 26 provided in the vicinity of the zone by means of which it is to be mounted on the shaft of the machine.

The grooves 22, 24 and 26 form a visual code. They are associated with means 28 for reading this code which consist of means for the remote detection of the grooves 22, 24 and 26.

As may be seen particularly from FIG. 2, the reading means 28 comprise sets of optical fibres 30, 32 and 34, each intended for detecting a groove.

For this purpose, the free end of each of the optical fibres faces towards a location provided for one of the grooves, the opposite end being connected to a connector 36 of the central unit 16 (FIG. 1).

The sets of optical fibres 30, 32 and 34 are each placed in a protective sheath, such as 37, in which a lateral hole 37a is made for the passage of light, and are mounted axially displaceably in a sleeve 38, 40, 42, of which one of the branches, such as the branch 44 of the sleeve 38, receives the optical fibres 30 and of which the other branch 46 receives, for example, a screw 48 making it possible to lock optical fibres in position.

In fact, the sets of optical fibres 30, 32, 34 each comprise a transmitting fibre and a receiving fibre or fibre for reading the light transmitted by the transmitting fibre and reflected by the surface of the spindle 14.

According to the embodiment illustrated in FIG. 3, the grooves 22, 24, 26 of the spindle 14 have associated with them optical illuminating fibres 50a, 52a, 54a and optical reading fibres 50b, 52b, 54b.

Each optical illuminating fibre 50a, 52a, 54a and its optical fibre 50b, 52b, 54b for detecting or reading the presence of a groove 22, 24, 26 are mounted opposite one another at a distance from the axis of the spindle 14 which is between the distance from the bottom of the corresponding groove to said axis and that from the outer peripheral surface of the spindle 14 to said axis.

Thus, when a groove is present in the light beam transmitted by one of the fibres 50a, 52a, 54a, there is direct illumination of the corresponding optical reading fibre 50b, 52b, 54b, and, in the absence of a groove, the spindle 14 masks the light transmitted by the illuminating fibre, so that the corresponding reading fibre is not illuminated.

As may be appreciated, the presence of a groove 22, 24 and 26 brings about a consequential change in the light intensity of the optical signal transmitted by the corresponding optical reading fibre to the central unit 16.

After processing, particularly by filtering, and after a comparison of the optical signals with a groove detection threshold, the central unit 16 prepares a word.

For example, in the example illustrated in FIG. 2, in which the toolholder spindle 14 comprises three grooves, the word prepared by the central processing unit 16 is “111”.

By contrast, an absence of grooves results in the preparation of a word “000”. As may be appreciated, such a word is interpreted as the absence of a toolholder spindle.

After the word has been prepared, the central unit 16, with the aid of a suitable algorithm, carries out a comparison of the word with a set of words stored in a memory and each corresponding, on the one hand, to a type of machining tool fitted to the toolholder spindle which corresponds to the type of tool indicated by the visual code 18 and, on the other hand, to a machining programme which is matched to the tool.

The unit 16 then automatically selects the machining program which corresponds to the type of tool indicated by the visual code 18.

The program, retrieved in this way, is then triggered in order to carry out the machining of a workpiece.

In the exemplary embodiment just described, in which the toolholder spindle is equipped with three grooves and the reading means 28 comprise three optical fibres, seven machining programs, which each correspond to a specific type of tool, may be triggered.

It will be appreciated, however, that the spindle 14 may be equipped with a larger or smaller number of such grooves, depending on the number of tools which the machine is capable of receiving. In this case, of course, a corresponding number of optical fibres is provided.

It will be appreciated that the invention just described, which makes use of means for the non-contact detection of the grooves, makes it possible to dispense with any variation in diameter of the toolholder spindles.

In more general terms, any reliefs may be used to form the visual code, for example grooves, projections and combinations of these.

It was found, furthermore, that the use of coding means taking the form of a visual code and of detection means comprising optical fibres allows effective detection of the type of tool carried by the spindle, even when dirt is present on the surface of the spindle carrying the code 18.

Although the invention applies to a pneumatic machining machine in the examples described above, it can easily be understood that it may apply to any machining machine using a multiplicity of tools and containing in its central processing unit programs matched to the various tools used.

In other variants, not illustrated, the coding means and the reading means may be magnetic, rather than optical, thus also making it possible to ensure effective detection of the type of tool carried by the spindle, even when dirt is present.

1. Machining machine, comprising a toolholder spindle (14), drive means ensuring the drive of the spindle and a central unit (16) which stores programs for controlling the drive means for the execution of machining cycles as a function of the type of tool carried by the spindle (14), characterized in that said spindle is equipped with means (20) for coding the type of tool which it carries, and the machine is provided with means (28) for reading the coding means, which are connected to the central unit (16) in order to supply the latter with information relating to the tool fitted to the spindle, and in that the central unit comprises, furthermore, means for selecting from the programs stored in the central unit the program corresponding to the tool which is held by the spindle and the coding means of which are read by the reading means.

2. Machine according to claim 1, characterized in that the coding means are arranged in the form of a set of annular grooves (22, 24, 26) made on the peripheral surface of the spindle (14), and in that the reading means (28) consist of means for the non-contact detection of said grooves.

3. Machine according to claim 2, characterized in that the means (28) for reading the coding means comprise a network of optical fibres (30, 32, 50a, 50b, 52a, 52b, 54a, 54b) facing towards the grooves and intended for detecting the presence of said grooves on the spindle (14).

4. Machine according to claim 3, characterized in that the network of optical fibres comprises optical fibres (50b, 52b, 54b) for detecting the presence of said grooves, with each of which optical fibres is associated an optical fibre (50a, 52a, 54a) for illuminating the peripheral surface of the spindle (14) carrying said grooves (22, 24, 26).

5. Machine according to claim 4, characterized in that each optical illuminating fibre associated with an optical fibre for detecting the presence of a groove (22, 24, 26) is assembled in a bundle with the associated optical detection fibre and ensures that the latter is illuminated by reflection on the peripheral surface of the spindle (14).

6. Machine according to claim 4, characterized in that each optical illuminating fibre (50a, 52a, 54a) and its optical fibre (Sob, 52b, 54b) for detecting the presence of a groove (22, 24, 26) are mounted opposite one another at a distance from the axis of the spindle (14) which is between the distance from the bottom of the corresponding groove (22, 24, 26) to said axis and that from the outer surface of the spindle (14) to said axis.

7. Machine according to claim 3, characterized in that the selection means comprise, in the central unit (16), means for comparison between a word prepared from the signal carried by the network of optical fibres and a set of words which are stored in a memory in the central unit, each corresponding to one type of machining tool and with each of which is associated a corresponding machining program.

8. Machine according to claim 7, characterized in that it comprises three optical fibres (50a, 52a, 54a, 50b, 52b, 54b) for preparing a word of three binary digits serving for controlling the execution of corresponding machining programs.

9. Machine according to claim 1, characterized in that the toolholder spindle (14) comprises, furthermore, a visual code (18) intended for indicating to an operator the type of tool to be fitted to the spindle, the type of tool indicated by the visual code corresponding to the type of tool coded by the coding means.

10. Machine according to any one of the preceding claims, characterized in that the drive means ensure the advance of the toolholder spindle (14), and the control programs are programs for controlling the advance of the toolholder spindle (14).
